(19) United States
(12) Patent Application Publication
(10) Pub. No.: US 2008/0041532 A1
(43) Pub. Date: Feb. 21, 2008

(54) SYSTEM FOR FABRICATING NANOPARTICLES

(75) Inventors: Po-Fu Chou, Toyuan County (TW); Pei Kan, Hsinchu City (TW); En-Wei Chang, Taichung County (TW); Shun-Chuan Lin, Hsinchu (TW); Wei-Liang Hsu, Taipei City (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/562,958

(22) Filed: Nov. 22, 2006

(30) Foreign Application Priority Data
Aug. 7, 2006 (TW) TW95128839

(51) Int. Cl. B01D 1/16

(52) U.S. Cl. 159/48.1; 347/47

(57) ABSTRACT

A system for fabricating nanoparticles that includes a micro droplet sprayer, a device, and a drying chamber is disclosed. The micro droplet sprayer, such as an inkjet sprayer, composed of a tank, a channel, an actuator, and orifices is utilized for generation of micro droplets. The device is employed to provide the micro droplet sprayer with energy, thus, forcing droplets out. The droplets are dried in the drying chamber, obtaining nanoparticles.

### BACKGROUND OF THE INVENTION

1. Field of the Invention

The invention relates to a system, and more particularly to a system for fabricating nanoparticles.

2. Description of the Related Art

Nanotechnology is widely used in various fields such as biochemistry, medicine and chemical engineering. Regarding to medicine transfer in the biomedical field, for example, nanorization of medicines can effectively increase the total particle surface area of medicines, thus accelerating absorption rate of medicines and bioavailability. The key point of therapy using medicines is whether the medicines can be essentially (or completely) absorbed, thus particle dimensions and uniformity may directly influence the therapeutic effect.

Present nanorization of medicines may comprise physical and chemical methods. Physical methods include, for example, electrospray, ultrasound, spray drying, superior fluid, and cryogenic technology. Specifically, electrospraying, disclosed in U.S. Pat. No. 3,208,951 has drawbacks such as varying particle diameters and residue of organic solvent; ultrasound disclosed in U.S. Pat. No. 5,389,379 and superior fluid disclosed in U.S. Pat. No. 5,639,441, U.S. Pat. No. 6,095,134 and U.S. Pat. No. 6,630,121 fail to fabricate particles with uniform diameters. Spray drying disclosed in U.S. Pat. No. 3,208,951 spray droplets by compressed air, also has the same problem of uniform particle diameter. Additionally, spray drying fails to nanorize particles. U.S. Pat. No. 5,015,332 discloses a typical air compressed type spray drier for drying chemical particles which have an average particle diameter between abut 60˜70 nm. A wet polishing technology disclosed in U.S. Pat. No. 6,582,285 and U.S. Pat. No. 6,431,478 has issues such as process contamination and uneven distribution in particle diameters. As described, the methods respectively have the following disadvantages e.g. irregular distribution of droplets sprayed, residue of organic solvent and inefficient formation of particles. In addition, not all methods are suitable for large-scale production. As to chemical methods, emulsion polymerization, interface polymerization and coagulation/phase separation are popular and most of them can fabricate nanoparticles, however, problems such as difficult scale up and bad particle diameter distribution.

As described, most technologies have a common issue i.e. uneven distribution of particle diameters, which can be solved by subsequent filtering, however, manufacturing process complexity, and cost also increases. Accordingly, processes suitable for large-scale production capable of obtaining nanoparticles with uniform diameter are desirable.

### BRIEF SUMMARY OF THE INVENTION

The invention features fabrication of nano particles using an inkjet printing technique followed by a subsequent drying process. That is, micro droplets are generated utilizing an inkjet sprayer for leasing easing (i.e. spraying), and nanoparticles are then obtained by means of a subsequent drying process.

One embodiment of the invention provides a system for fabricating nanoparticles that includes a micro droplet sprayer, a device, and a drying chamber. The micro droplet sprayer, such as an inkjet sprayer, composed of a tank, a channel, an actuator, and orifices is utilized for generation of micro droplets. The device is employed to provide the micro droplet sprayer with energy, thus, forcing the droplets out. The droplets are dried in the drying chamber, thus nanoparticles are obtained.

Another embodiment of the invention provides a system for fabricating nanoparticles that includes a micro droplet sprayer, a pressure controller, a device, and a drying chamber. The micro droplet sprayer, such as an inkjet sprayer, composed of a tank, a channel, an actuator, and orifices is utilized for generation of micro droplets. The pressure controller for maintaining stability of the micro droplet sprayer, avoiding variation of pressure caused by volume change of solutions during operation. The device is employed to provide the micro droplet sprayer with energy, thus, forcing the droplets out. The droplets are dried in the drying chamber, thus nanoparticles are obtained.

Another embodiment of the invention provides a system for fabricating nanoparticles that further includes a particle collector for collecting the nanoparticles.

Another embodiment of the invention provides a system for fabricating nanoparticles that further includes an auxiliary element for controlling spray directions of the droplets, avoiding turbulence or collision therebetween during operation of micro droplet sprayer. The auxiliary element is arranged in a front end of the micro droplet sprayer, preventing the droplets sprayed out from being affected by the air flow. As a result, problems such as distribution of various particle sizes due to turbulence or collision between the droplets are solved.

The inkjet technique has advantages such as low cost, fine droplet and uniformity of droplet diameter, so nanoparticles with uniform diameter can be fabricated by integrating the inkjet technique into the subsequent drying process without requiring complicated apparatuses and high cost. Additionally, the integrated technique or process can be applied to various fields e.g. optoelectronics, chemistry and biomedicine.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows one embodiment of a nanoparticle fabrication method.

FIG. 2 shows one embodiment of a system for fabricating nanoparticles.

FIG. 3 shows an enlarged view of the micro droplet sprayer 220 of the system shown in the FIG. 2.

FIG. 4 shows an enlarged view of the micro droplet sprayer 220 of the system shown in the FIG. 2.

FIG. 5 shows the distribution of diameter for nanoparticles obtained by one embodiment of the invention.

FIG. 6 shows another embodiment of a system for fabricating nanoparticles.

FIG. 7 shows the distribution of diameter for nanoparticles obtained by another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

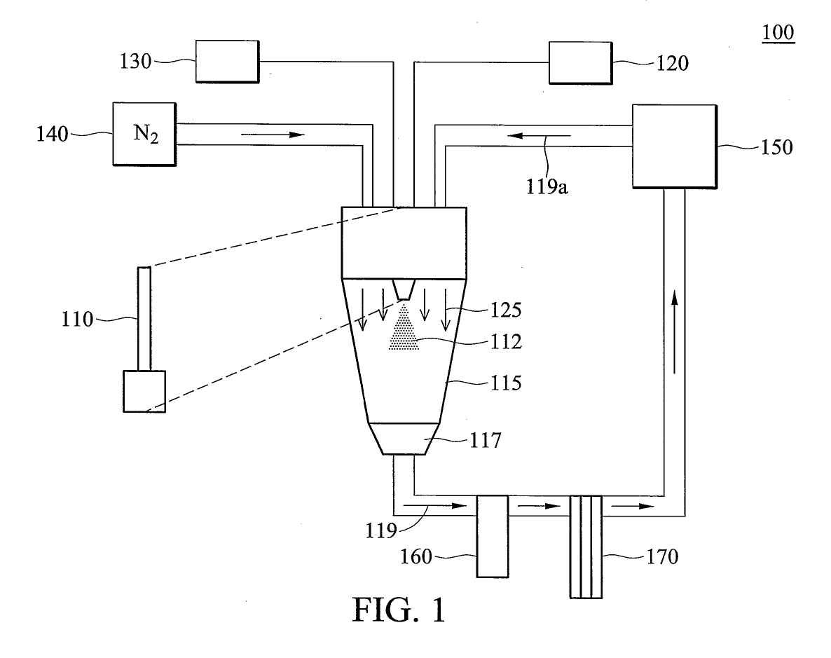

FIG. 1 shows an embodiment of a nanoparticle fabrication method. As shown in FIG. 1, the system 100 includes a micro droplet sprayer 110, a drying chamber 115, a liquid supplier and a pressure controller 120 of the micro droplet sprayer 110, a device (e.g. a controller or a control system) 130 of the micro droplet sprayer 110, a nitrogen supplier 140 of the system 100, an inner loop 150 of the system 100, a particle collector 160 and a particle filter 170.

The micro droplet sprayer 110, for example, can be an inkjet sprayer including a liquid tank (not shown), a channel (not shown), an actuator (not shown), and orifices (not shown). The actuator drives several orifices to spray the solution, thus micro droplets 112 are generated. The actuator can be a thermal bubble actuator or a piezoelectric actuator. In this embodiment, the solution, such as a medicine solution containing 2.5% solid by weight, employing alcohol as a solvent is poured into the micro droplet sprayer 110. The drying chamber 115 is used to collect and dry the droplets 112, and it can be a thermal dryer or a hot air generator. The liquid supplier and pressure controller 120 are capable of supplying liquid steadily and controlling the pressure required by micro droplet sprayer 110, thus avoiding the pressure change rendered by the volume change of solution during operation. Driving forces of the pressure controller 120 comprise mechanical forces, atmosphere difference or potential difference. The device (e.g. a controller or a control system) 130 can provide the micro droplet sprayer 110 with various energy pulses or other parameters for spraying liquid. The nitrogen suppliers 140 are provided for keeping oxygen concentration to less than a specific value by steadily providing the system with nitrogen because the system 100 utilizes an organic solvent as solvent of the medicinal solution to be sprayed and is operated under high temperature that may cause an explosion. In other embodiments, the system 100 can also use water as solvent. The inner loop 150 can recycle the nitrogen (the heated nitrogen can be used as hot air) and condense organic solvent for collection. The particle collector 160 and particle filter 170 can prevent particles from escaping into the air.

In this embodiment, the liquid supplier and pressure controller 120 inject the medicine solution into the micro droplet sprayer 110. In addition, The micro droplet sprayer 110 is driven by the device (e.g. a controller or a control system) 130 to spray the medicine solution, thus micro droplets 112 are formed in the drying chamber 115. The nitrogen supplier 140 simultaneously injects nitrogen into the drying chamber 115, generating hot air 125 and drying the micro droplets 112 released from the micro droplet sprayer 110. As a result, nanoparticles (i.e. the dried micro droplets 112) are obtained. The nanoparticles then settle to the bottom 117 of drying chamber 115 for collection by the particle collector 160 following the direction of arrow 119. The nanoparticles, remaining in the nitrogen, however, are trapped by the particle filter 170. The used nitrogen is then recycled by means of the inner loop 150 and enters the drying chamber 115 again. In this embodiment, an auxiliary element (not shown) for controlling spray directions of the droplets 112, thus avoiding turbulence or collision therebetween during operation of micro droplet sprayer 110. In addition, the auxiliary element is arranged in a front end of the micro droplet sprayer and the shape of the auxiliary element is cylindrical or conical.

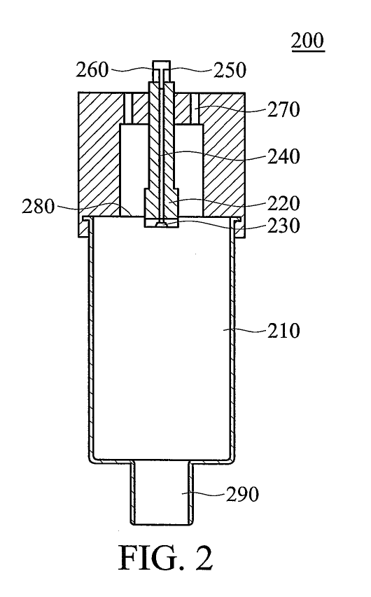

FIG. 2 shows one embodiment of a system for fabricating nanoparticles. As shown in FIG. 2, the system 200 e.g. a hot air drying system dries the droplets using hot air, thus, nanoparticles are formed. The system 200 includes a drying chamber 210, micro droplet sprayer 220, orifices 230 of micro droplet sprayer, pipes 240, nitrogen entrance 250, water (from circulation chamber) entrance 260, hot air entrance 270, hot air exit 280, and the bottom 290 of drying chamber 210.

The drying chamber 210 is used to dry the droplets. The micro droplet sprayer 220 e.g. an inject head can steadily spray the droplets from the orifices 230. The pipes 240 connected to the liquid supplier and pressure controller (e.g. the liquid supplier and pressure controller 120 shown in FIG. 1) can supply the liquid steadily. Nitrogen enters the drying chamber 210 by way of the entrance 250. Water from the circulation chamber, provided for keeping solutions e.g. a medicine solution at a specific temperature, enters the system by way of the entrance 260. Hot air, however, enters the drying chamber 210 by way of entrance 270, drying the droplets released from the micro droplet sprayer 220 and leaving the drying chamber 210 by way of exit 280. The nanoparticles then settle to the bottom 290 of drying chamber 210.

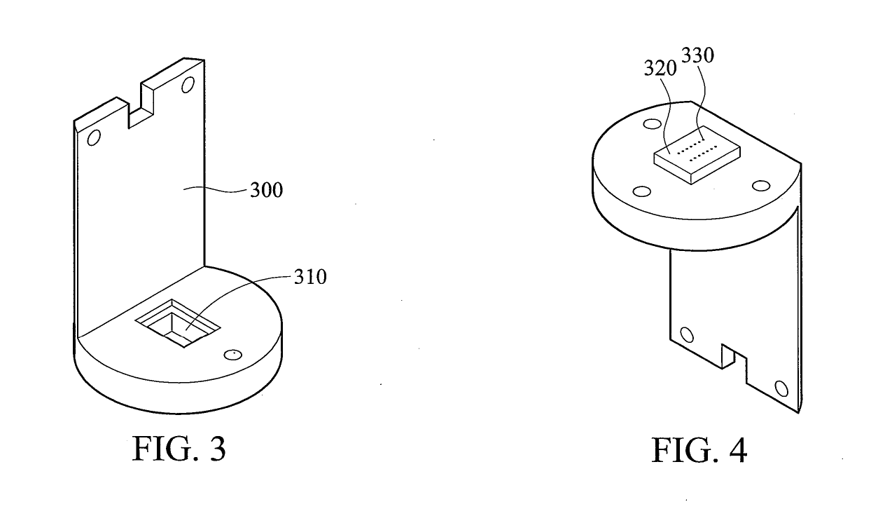

FIG. 3 shows an enlarged view of the micro droplet sprayer 220 of the system 200 shown in the FIG. 2. The micro droplet sprayer 220 can be an inject type micro droplet sprayer 300 in which there is a liquid tank 310 (also a liquid entrance). Specifically, liquids flow through the liquid tank 310 to reach micro liquid channels of the chips (not shown), and are then sprayed.

As shown in FIG. 4, 320 designates a chip with micro liquid channels of the injection type micro droplet sprayer 300; 330 designates micro orifices of the injection type micro droplet sprayer 300.

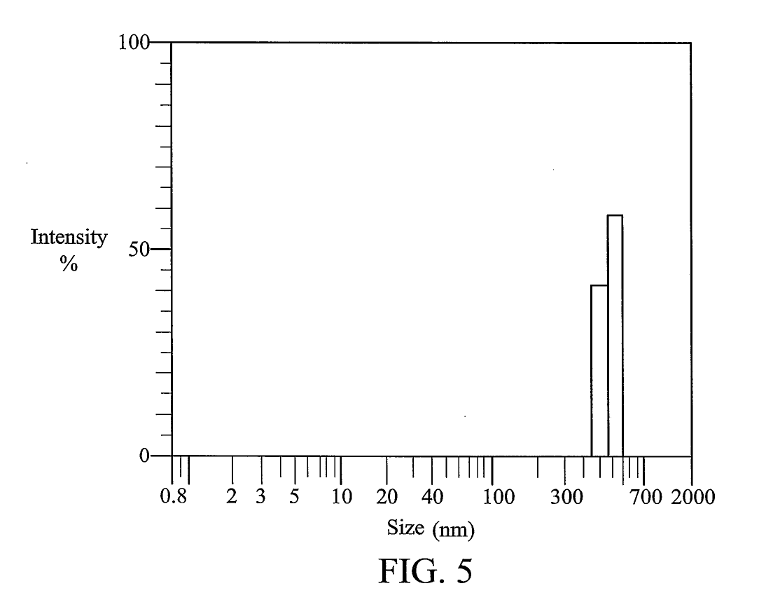

As shown in FIG. 1, the processes and parameters for the system 100 are described as the following. First, the drying chamber 115 is filled with nitrogen and heated to a desired temperature e.g., 100° C. When the system reaches a steady state, the micro droplet sprayer 110 is driven to steadily spray the medicinal solution, forming the droplets 112. In addition, the medicinal solution includes alcohol as solvent and the spray frequency is 0.3 kHz. Subsequently, nanoparticles are rapidly obtained due to the small size of the droplets 112 are tiny and sprayed into a high temperature ambient. Specifically, the described nanoparticles have uniform diameters due to recipes of the solutions. Finally, nanoparticles are collected by the particle collector 160. FIG. 5 shows the distribution of diameter for nanoparticles obtained by an embodiment of the invention. As shown in FIG. 5, the average particle diameter is 576.0 nm and particle' diameters are uniform showing that the system 100 fabricates nanoparticles with uniform diameters.

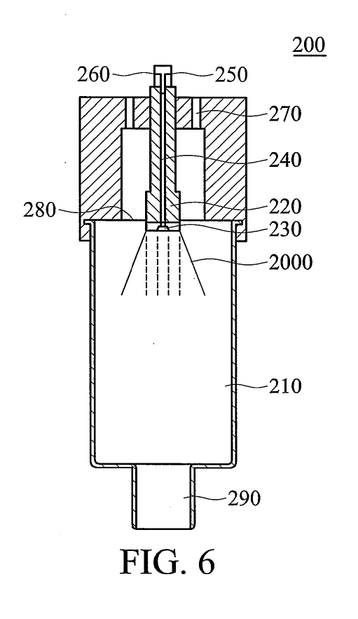

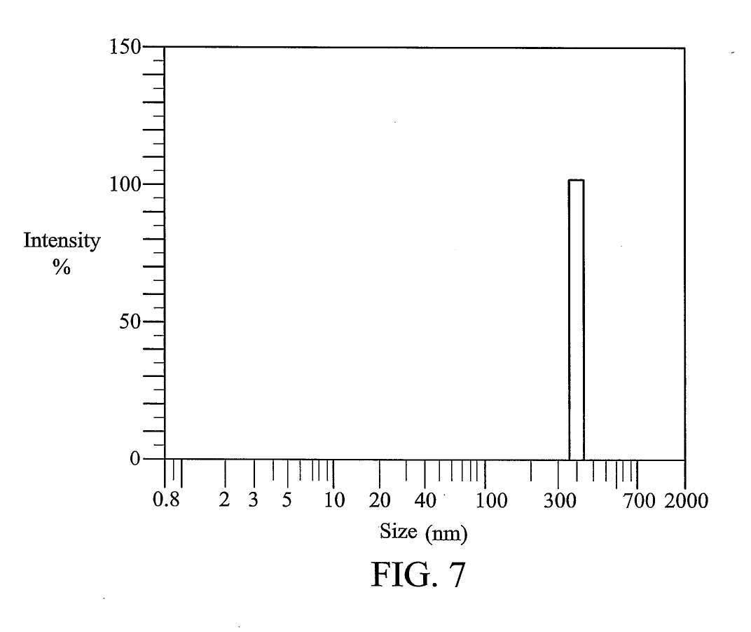

FIG. 6 shows another embodiment of a system for fabricating nanoparticles. As shown in FIG. 6, there are no differences from the system 200 shown in FIG. 2 except the addition of a conic element 2000 to the orifices 230. The conic element 2000 is an auxiliary element used to control spray directions of the droplets, avoiding turbulence or collision therebetween during operation of micro droplet sprayer. The uniformity of particles and the production stability are thus maintained. Descriptions of experimental procedures and system parameters of this embodiment are omitted as they are identical to the previously disclosed embodiment. Results of this embodiment are shown in FIG. 7, indicating that the average particle diameter is 398.0 nm and particle diameters are more uniform. Namely, the system accompanying a conic element 2000 fabricates nanoparticles with uniform diameters. In other embodiments, the conic element 2000 can be replaced with a cylindrical element.

As described, the invention fabricates nanoparticles with uniform diameters by integrating injection printing techniques into subsequent drying and formation processes. In addition, the system is further equipped with the auxiliary element for controlling spray directions of the droplets and particle collector for collecting dried nanoparticles. Compared to the related art, the invention has advantages such as low cost, fine droplets, uniform droplet diameters, and simple apparatus and processes. Specifically, the nanoparticles fabricated by the invention have uniform particle diameters, thus, they can be used to manufacture medicines enhancing absorption and solubility in the blood. The invention aids in improving the therapeutic effect of medicines.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for fabricating nanoparticles, comprising:
a micro droplet sprayer, wherein the micro droplet sprayer is an inkjet sprayer utilized for generation of micro droplets;
a device employed to provide the micro droplet sprayer with energy, forcing the droplets out; and
a drying chamber, wherein the droplets are dried therein.

2. The system as claimed in claim 1, wherein the micro droplet sprayer comprises an actuator which is a thermal bubble actuator or a piezoelectric actuator.

3. The system as claimed in claim 1, wherein the actuator is employed to drive a single orifice or a plurality of orifices.

4. The system as claimed in claim 1, wherein the drying chamber is a thermal dryer.

5. The system as claimed in claim 1, wherein the drying chamber is a hot air generator.

6. The system as claimed in claim 1, wherein gases employed in the drying chamber comprise nitrogen.

7. The system as claimed in claim 1, wherein a solvent employed in the micro droplet sprayer comprises an organic solvent or water.

8. A system for fabricating nanoparticles, comprising:
a micro droplet sprayer, wherein the micro droplet sprayer is an inkjet sprayer utilized for generation of micro droplets;
a pressure controller for maintaining stability of the micro droplet sprayer, avoiding variation of pressure caused by volume change of solutions during operation;
a device employed to provide the micro droplet sprayer with energy, forcing the droplets out; and
a drying chamber, wherein the droplets are dried therein.

9. The system as claimed in claim 8, wherein the micro droplet sprayer comprises an actuator that is a thermal bubble actuator or a piezoelectric actuator.

10. The system as claimed in claim 8, wherein driving forces of the pressure controller comprise mechanical forces, atmospheric difference or potential difference.

11. The system as claimed in claim 8, wherein the drying chamber is a hot air generator.

12. The system as claimed in claim 8, further comprising:
a particle collector for collecting the nanoparticles.

13. The system as claimed in claim 8, further comprising:
an auxiliary element for controlling spray directions of the droplets, avoiding turbulence or collision therebetween during operation of micro droplet sprayer.

14. The system as claimed in claim 13, wherein the auxiliary element is cylindrical or conical and arranged in a front end of the micro droplet sprayer.
